(19) United States
(12) Patent Application Publication
(10) Pub. No.: US 2012/0310670 A1
(43) Pub. Date: Dec. 6, 2012

(54) SYSTEMS AND METHODS FOR AUTOMATED INFORMED CONSENT

(75) Inventor: Brad Pruitt, Del Mar, CA (US)

(73) Assignee: nPruv, Inc., Del Mar, CA (US)

(21) Appl. No.: 13/487,155

(22) Filed: Jun. 1, 2012

Related U.S. Application Data
(60) Provisional application No. 61/492,359, filed on Jun. 1, 2011.

(51) Int. Cl. G06Q 50/22; G06Q 50/24

(52) U.S. Cl. 705/3; 705/2

(57) ABSTRACT

An automated, personalized informed consent creation and verification process is provided herein. Multimedia, interactive informed consent presentations may be created for medical procedures or clinical trials which are procedure-specific or trial-specific by providing standardized disclosure information to a patient regarding a specific medical procedure or clinical trial which is being performed. The presentation is also patient specific by using the patient's medical history to personalize the disclosures regarding risk and expected outcome of the procedure. The presentation may be provided on a computer, such as a tablet, where the patient views and interacts with the informed consent presentation to ask and answer questions, indicate their capacity to make a decision and verify comprehension of the content of the presentation. The patient's consent may be recorded in an audio or video record in order to more accurately capture the patient's consent and verify that the patient consented to the procedure.

### PRIORITY CLAIM

This application claims priority to U.S. Provisional Application No. 61/492,359, filed Jun. 1, 2011, now pending, the content of which is incorporated by reference herein in its entirety.

### BACKGROUND

1. Technical Field

The embodiments described herein relate to automating informed consent (IC) and clinical trial recruitment of a patient for a medical procedure, and more particularly to creating customized informed consent content and obtaining confirmation of the patient's awareness and understanding of the medical procedure, and using patient medical information to create a clinical trial recruitment system.

2. Related Art

Many patients understand little about medical treatments and procedures. Patients who do not understand their medical care cannot follow instructions or be compliant with instructions needed to perform, prepare and recover from a medical procedure. They don't know what to ask, feel left out of the decision making process and feel alienated from their own medical care, which may lead to distrust of their own doctor's judgment. As the misunderstandings compound, the seed of a malpractice lawsuit is planted and nourished.

The scope of the problem goes beyond the occasional uneducated or inattentive patient. According to a Stanford University report, most malpractice claims originate from “communication breakdown.” Despite legal mandate, patients are not being educated or “informed” to properly “consent” for procedures and treatments, which leads to high-dollar malpractice claims costing providers and taxpayers millions of dollars each year and poor patient outcomes

Informed consent is simply the communication to and understanding by the patient of “what is wrong,” the “purpose,” “options,” and “risks,” including the risk of not treating, and of all “alternative” treatment(s) available. ICs are mandated for medical intervention and clinical trial enrollment. ICs are intended to educate the patient. Additionally, ICs serve the purpose of protecting medical providers and clinical trial sponsors from legal claims in the event anything should go wrong during the procedure or course of treatment.

A recent study of oncologic clinical trials revealed 73% of IC reading material was college level or higher. Given that only 28% of US population attends college, and approximately 20% read functionally below fifth grade level, this is a recipe for misunderstanding. The “pain” extends beyond the informed consent process itself and into high costs of medical care.

Another study by Health Outcomes Research (Mid America Heart Inst.) of patients about to undergo cardiac surgery revealed:

69% patients admitted they had not read the consent forms they signed

44% could not describe the procedure to be performed

27% could not even name the organ to be operated on

The current paper-based method of informed consent (IC) involves many densely-worded legal forms and signatures that only benefits the contracted firms who prepare ICs and the malpractice lawyers who search for loopholes and file costly litigious claims. Malpractice claims in 2009 cost US hospitals $9 billion dollars. Lack of informed consent was among the top ten claims and was the most frequent secondary claim. In addition, every 60 seconds lost in the operating room due to misplaced consent forms cost $20 (2009). Medical providers, clinical trial sponsors, patients, and physicians all suffer under the current system.

The current method of patient education costs a physician time and money, and can lead to poor outcomes from a medical procedure. Current informed consent procedures are non-standardized, not well documented or validated. While it is believed that signed consent forms mean that a patient understands their treatment options and the risks of a medical procedure, it is often not the case. Uninformed patients who are not prepared for the medical procedure don't understand what the procedure entails and fail to achieve the desired outcome, which also leads to malpractice claims.

### SUMMARY

Embodiments described herein provide systems and methods for an automated personalized informed consent creation and verification process. Multimedia, interactive informed consent presentations may be created which are procedure-specific by providing standardized disclosure information to a patient regarding a specific medical procedure which is being performed. The informed consent presentation is also patient specific by using the patient's medical history to personalize the disclosures regarding risk and expected outcome of the procedure. The informed consent presentation may be provided on a computer, such as a tablet, where the patient views and interacts with the informed consent presentation to ask and answer questions, indicate their capacity to make a decision and verify comprehension of the content of the presentation. The patient's consent may be recorded in an audio and/or audio/video record in order to more accurately capture the patient's consent and verify that the patient consented to the procedure.

In one embodiment, a method for obtaining informed consent from a patient comprises displaying an informed consent presentation to the patient using a computer with a processor, memory and display; requesting the patient to provide oral consent after the informed consent presentation has finished; capturing at least one of an audio recording and video recording of the patient providing the oral consent as a multimedia file; and storing the multimedia file in a database.

In another embodiment, a system for obtaining informed consent from a patient comprises a presentation unit which displays an informed consent presentation to the patient using a computer with a processor, memory and display; an interaction unit which interacts with the patient during the informed consent presentation to receive feedback from the patient; a multimedia capture unit which captures at least one of an audio recording and a video recording of the patient providing oral consent as a multimedia file; and a storage unit which stores the multimedia file in a database.

From this description, in conjunction with other items, the advantages of the said invention will become clear and apparent more so based upon the hereinafter descriptions and claims, which are supported by drawings with numbers relating to parts, wherein are described in the following sections containing the relating numbers.

### BRIEF DESCRIPTION OF THE DRAWINGS

The accompanying drawings, which are incorporated in and constitute a part of the specification, illustrate embodiments of the invention and, together with the description, serve to explain the objects, advantages, and principles of the invention. In the drawings:

FIG. 1 illustrates a system for obtaining informed consent from a patient, according to one embodiment;

FIG. 2 illustrates a method for obtaining informed consent from a patient, according to one embodiment; and

FIG. 3 is a block diagram that illustrates an embodiment of a computer/server system upon which an embodiment of the inventive methodology may be implemented.

### DETAILED DESCRIPTION

After reading this description it will become apparent to one skilled in the art how to implement the invention in various alternative embodiments and alternative applications. However, all the various embodiments of the present invention will not be described herein. It is understood that the embodiments presented here are presented by way of an example only, and not limitation. As such, this detailed description of various alternative embodiments should not be construed to limit the scope or breadth of the present invention as set forth below.

Embodiments described herein provide for systems and methods for an automated informed consent process using a customized, interactive, multimedia informed consent presentation. The informed consent presentation establishes bona fide patient informed consent (IC) that educates and empowers the patient while protecting the medical provider according to all governing regulatory bodies, and brings clarity to these concepts through visual and auditory explanations. The system can prove to a legal certainty that the patient was competent and comprehended the IC.

In one embodiment, the informed consent presentation is a multi-media consent process that engages the patient in an educational experience in his or her own language to guide the patient through the educational process of informed consent prior to undergoing medical treatment or enrolling in a clinical trial. The informed consent application may be configured to: deliver all information needed for IC in a consist interactive multimedia form that is documented accurately; give oral and graphical description of procedure, risks, and options available; contain a quiz with patients responses to confirm comprehension; create a valid legal document stored on a electronic medical record; and review all up-to-date legal mandates for IC, including all options that must be discussed with the patient, both mainstream and complementary procedures available.

The systems and methods described also provide protected identity verification, time stamps, and embedded quizzes to determine patient capacity to consent and test patient knowledge and understanding of the medical procedure and associated risks. Thus, as opposed to paper consent, patients are properly informed and educated, are more likely to be proactive and involved in their own medical care, be more satisfied and with better health outcomes. The automated informed consent process improves operational efficiency, drives patients to customers, and provides improved health outcomes at a lower cost. This saves time and money

The informed consent process is a modular, multilingual, multimedia and personalized informed consent application that will bring clarity to concepts through visual and auditory explanations while also verifying, documenting and time stamping the patient's legal capacity, identity and consent certification. The patients are progressively quizzed during the informed consent presentation to ensure their understanding, and must answer a predetermined number of questions correctly before they are permitted to consent to a medical procedure or enroll in a given clinical trial for medical procedure or treatment. Embodiments may also include voice recognition that allows for those with physical impairments to use the system, too. The informed consent presentation is customized for each patient through seamless interoperability with electronic health records (EHR), electronic medical record (EMR) and personal health records (PHR). The informed consent presentation is applicable for all medical providers mandated to obtain patient consent for treatment.

Improved patient compliance, safety, and outcomes is the result of prepared patients who know what to expect and can ask questions with quality and verifiable patient understanding well before the day of the procedure. Standardized, consistent patient education that is procedure and patient specific conducted a computer or tablet device will improve patient education, understanding, and compliance. Reduced liability exposure for physicians, hospitals, and clinical trial sponsors will be the result of an informed consent process that is standardized, unbiased, recorded, time-stamped, and reviewable for the protection of both the patient and the medical provider or clinical trial sponsor. The value delivered to the customer is the paradoxical ability for physicians to spend less time with each patient on the informed consent process while at the same time improving patient education and the doctor-patient communication resulting in educated, empowered, satisfied, and compliant patients.

### System Overview

In one embodiment, a patient-centric application may be provided that will educate the patients and streamline the entire informed consent process for medical procedures, screenings, and clinical trial enrollment.

The initial system may comprise a plurality of application modules that allow a doctor, or hospital to quickly and easily assemble an automated consent program for a specific procedure. Some of these modules will be generic, i.e., patient information, introduction, explanation of the consent process, etc., and some will specific to the procedure or trial. Once the modules are assembled and the application is built, it can be loaded onto a mobile device, such as a tablet. When the patient arrives for a procedure they can be given the tablet, which will walk them through the consent process.

The application may be a series of videos and pictures, preferably with voice overlays explaining what is going to happen, the patient's options, risks, etc. While text can be included, it is generally avoided because people are less likely to read and understand text, and it is easier to build multiple language versions by swapping out the audio files.

At various points in the process, a test can be given to the patient, i.e., a few short multiple choice questions, designed to confirm that the patient understood the content. If a patient fails a test, the content can be replayed, new, more in depth information can be provided, etc. If a patient continues to “fail” the test, a nurse or doctor can be summoned to help clear up any questions.

The test may change the second time, i.e., instead of multiple choice, it may require an answer be spoken or typed in, the questions may change, etc., in order to ensure the patient is really comprehending.

Each application can also have a set of thresholds in terms of how many right answers or the minimum knowledge that is required to move on.

Once the patient has reviewed all the information, passed the required test, etc., they can provide consent, which can be recorded. For example, the patient may speak their consent, which can be captured via both video and audio recording through the camera and microphone included in the tablet; a digital signature or electronic signature pad can be used; or the patient may speak their consent and then sign a paper form, but the consent will also have been recorded.

Importantly, the consent is not necessarily just a signature or acknowledgement: rather it can be interactive requiring them to restate certain key information in response to a question, queue, prod, etc., or at least listen to key information and provide acknowledgement. In general, what is required for “consent” can be designed to include and verify all of the factors necessary to prove consent in a court of law, which are identity, capacity, and comprehension. A time stamp can also be included.

In addition, the camera included in the tablet can be used to record and analyze the patient's behavior, capacity, awareness, etc., in order to ensure the patient is capable of providing consent. If it appears that a problem exists, a nurse or doctor can be summoned to further evaluate the patient.

As a result, there is a clear record that the patient received the information, understood it, and consented.

The patient can be quizzed with respect to their education, mood, autonomy, i.e., desire to know about health data, language, and reading level, and their comprehension can be tiered accordingly, but so as to ensure that a legal consent is obtained. Moreover, a patient can be requested to provide consent and other information above and beyond what would normally be obtained, in order to recruit them for clinical trials later on.

In general, the consent data, i.e., all the information gathered during the process can be stored in a database. With the added information, the patient data can be filtered based on the needs of a particular trial in order to identify potential candidates. In certain embodiments, all of the data is stored in a cloud based storage system.

Ultimately, the storage system can be linked to electronic health records, which can enable a host of additional services.

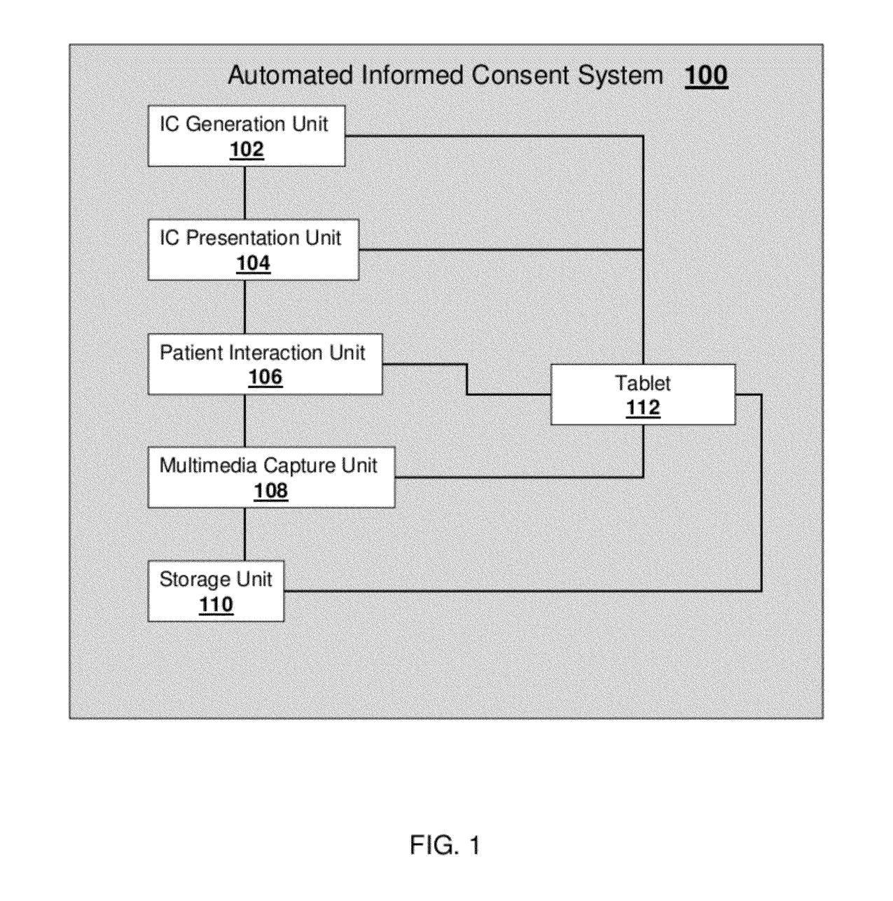

One embodiment of a system for automating informed consent is illustrated in FIG. 1. An IC Generation Unit 102 is used to generate an informed consent presentation, based on the procedures that the patient will be undergoing, the patient's medical history and any other factors that the person creating the presentation decides to include. Next, an IC Presentation Unit 104 transmits the presentation to a computer, such as a tablet 112, for displaying to the patient. The computer may be any type of computing device—portable or otherwise—as long as it includes a processor, memory and a display screen to display the informed consent presentation to the patient. The computer also needs an audio capture device, such as a microphone, to capture the audio of the user providing consent, or an image capture device, such as a camera, to capture the video of the user providing consent. If the computer is a tablet 112, the display screen of the tablet (not shown) may also be the input device where the patient provides input. If the computer is a more traditional desktop or laptop computer, a separate input device, such as a keyboard, mouse or physical input buttons may be used.

During the presentation of the informed consent presentation to the patient, the patient interaction unit 106 coordinates patient interaction with the tablet 112 in response to questions or instructions during the presentation. This includes responses to a mental capacity test, a reading comprehension test, a content comprehension test and any other interactions or feedback that the patient provides during the presentation.

In one embodiment, at some point during or at the end of the informed consent presentation, the patient may be requested to provide their oral consent by stating that they consent to a particular procedure, that they agree to enroll in a particular clinical trial program, or some other statement relevant to providing consent. A multimedia capture unit 108 will coordinate the capture of the patient's oral consent using the audio or video (or both audio and video) captured by the tablet 112. Once the audio or video is captured, the storage unit 110 will store a resulting multimedia file in a database (not shown) for later access. The file may be a known multimedia file for any type of audio or video, or the file may be stored in a particular format required for protected medical data, such as HL7.

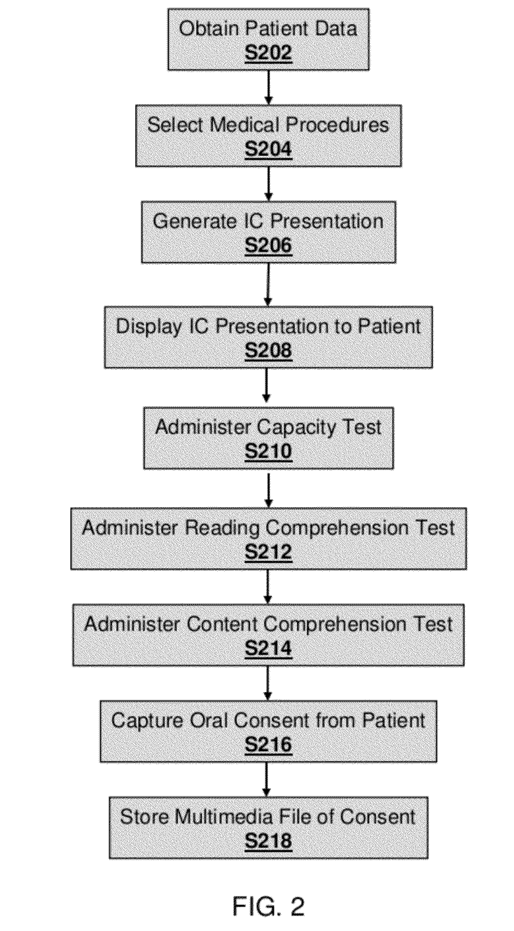

One embodiment of a method of capturing informed consent from a patient is illustrated in FIG. 2. In one step S202, patient data is obtained from a patient's medical records, genomic data, patient input, etc. In step S204, at least one medical procedure or clinical trial is selected by a health care professional. Next, in step S206, an informed consent presentation is generated based on the selected medical procedures and the patient data. For example, if the patient medical data indicates that the patient has a particular medical condition which increases the risk of the selected medical procedures or clinical trial, the informed consent presentation will be amended to tell the user of this increased risk. The informed consent presentation may also be amended in real time during the presentation to the patient if the patient provides new medical information which affects the risk of the selected procedures.

In step S208, the informed consent presentation is displayed to the patient on a display screen of a computing device, such as a tablet, phone, laptop or desktop computing device. As part of the overall informed consent presentation, the patient may be given a capacity test S210 to measure their mental ability to provide consent, a reading comprehension test S212 to determine the patient's ability to understand the medical language used in the presentation, and a content comprehension test S214 to determine whether the patient understood the information provided on the medical procedure, the risks involved, and the implications of their consent to the procedure.

The patient will then be asked to provide an oral statement of their consent to the medical procedure and any other statement of understanding that may be necessary. In step S216, this oral statement is captured by the tablet or computing device using a microphone or camera, and the resulting multimedia file is then stored (step S218) as part of the patient's overall consent files.

In addition to the patient's oral statement, the patient may also provide an electronic written consent by digitally or biometrically signing a form on the display screen, by typing their initials or name in a particular box, or providing some other type of written authorization that can be stored in another type of file.

### Capturing Patient Consent

In one embodiment, the consent process is recorded, reviewable, and archived to assure regulatory compliance for clinical trial sponsors and medical providers according to all governing regulation.

In the systems and methods described herein, an application such as that running on a tablet computer is provided to bring together digitized IC, mobile patient education, and secure health care access. In one embodiment, the system for automated informed consent is a cloud-based interactive multimedia application which is executed on a tablet, mobile phone or other portable media device connected to a network by a network cable or wirelessly. The system may also be run as a web-based application where the patient can access and interact with the presentation from any computer connected to a network. The tablet or computer running the informed consent application may include a camera or microphone so that the user's consent may be captured on video or audio (or both) and stored. The video and audio will provide additional evidence of the user's consent by recording their voice intonations, eye movement, and overall behavior. The patient may be asked to recite specific sections during the capture of the video or audio which pertain to their actual consent to the procedure or acknowledgement of a particular high risk. The video or audio file may be time-stamped as well. The patient's answers and recorded consent may be stored remotely on a central server or cloud, both for security of the data and to avoid loss of data stored on the computer running the application.

The format of the captured audio and video may be in HL7 (Health Level 7) compliant formats, although it may be separate from a more traditional informed consent file, which is typically stored in a portable document file (PDF) format.

### Obtaining Patient Information

The patient may be tested to determine their educational level, mood, autonomy (desire to learn about the procedure or clinical trial), language and reading level, etc. The minimum thresholds required for consent may be raised or lowered depending on this information. In addition, providing a patient with options to learn more about a procedure during the presentation will also increase the patient's overall comfort with the procedure. Information on the patient's mood may be provided to the doctor who is performing the procedure in order to alert them that the patient is apprehensive or may need further counselling regarding the procedure.

By obtaining information about the user's comprehension and overall capabilities, the patients can be “tiered” into predetermined levels so that the informed consent presentation is customized for the tier that the patient falls into. The informed consent presentation may also provide options for patients to obtain more information about a procedure, alternatives and risks if the user wants to know more. Even specific details such as the history and experience of the physician performing the procedure, the length of the procedure, environment in the procedure room, etc. may be provided. The additional details may put some patients at ease if they know more about the experience before going in.

In one embodiment, the informed consent process would consist of a very simple “patient check-in” process without the need for billing/insurance checks—just the basic demographic info for the patient, with their address and any other info needed to pay the patient (address, social security number, W9, etc). It would have audio/video recording of patient consent with some simple guidance, administer quizzes of the content, and provide the ability for the patient to flag confusing info that they want to review before consent with the health care provider.

In one embodiment, the patient may provide additional information that can be used for future evaluations of the procedure and options for other medical treatments, including enrollment in clinical trials. The patient may complete an overall health profile, enter geographic and demographic information and other information that may be used to offer the patient new treatments, medications or opportunities for clinical trials. The patient information is then stored in a database where it can be accessed by the physician, a health care provider or company that is looking for patients that may benefit from new treatments, drugs or clinical trial testing.

In another embodiment, the patient's medical records, including the EMR, EHR and PMR may be obtained and used to customize the informed consent presentation. This may include their genomic data as well. For example, certain procedures may be more risky for patients with certain conditions, so the presentation may be customized to explain this heightened risk to the patient if their records indicate they have another condition or if they indicate that they have a certain condition during the informed consent process. Furthermore, their medical record data may be stored in the overall consent database for future access by the physician, health care provider or company looking for patients for new treatments, drugs or clinical trials.

### Modular Informed Consent

The informed consent system may be modular, in that separate informed consent presentations may be created for each medical procedure, clinical trial or other component of informed consent. In one embodiment, when the procedures that a patient will be undergoing is entered into a medical software system, the unique code (CPT, for example) or procedure selected may automatically trigger the creation of the informed consent presentation with presentations corresponding to each code or procedure selected. Other modules, such as a capacity evaluation module (described below) may also be included in the overall presentation. Each module selected may then be integrated into a single presentation that is given to the patient.

### Capacity Evaluation

In one embodiment, one portion of the informed consent presentation is a capacity evaluation test that determines whether the patient possesses the mental capacity to make an informed consent decision. Physicians often ask patients to make complex choices about diagnostic studies or treatments. Medical decision-making capacity includes a patient's ability to understand relevant information and appreciate the consequences of a decision. Clinicians often do not assess and lack formal training in assessing patients' capacity. As a result, clinicians regularly fail to identify patients who are incapable of informed decision-making, despite the prerequisite of capacity for valid informed consent. Researchers reviewed more than 40 high-quality prospective studies of inpatients, outpatients, and healthy controls in which medical decision-making capacity was evaluated with various instruments; patients with severe psychiatric illness were excluded. Incapacity (as judged by a gold standard of forensic or expert psychiatric evaluation) was common in medical inpatients (26%), and physicians missed identifying patients with incapacity 58% of the time. In one embodiment, the ACE Capacity Evaluation Tool may be included in the informed consent presentation to evaluate a patient's actual decisions, which unlike other instruments focuses on unrelated clinical vignettes.

The patient may also be evaluated to establish a reading comprehension level to adjust the informed consent presentation to that patient's reading level and ensure complete understanding of the medical procedure. The patient may be asked what their educational level is, or they may be given a series of reading comprehension-like questions to evaluate their reading comprehension level indirectly.

### Comprehension

In one embodiment, the patient's comprehension of the informed consent presentation is measured to ensure that the patient understood the material and remembers important aspects. By the use of a modular learning management system (LMS) with interactive quizzes, repeat back questioning and scored performance, the medical provider and trial sponsors can be assured that the patients have full knowledge of what their diagnosis is, why they are enrolling in a trial or having a procedure done, the alternatives available and the risks of the trial or procedure, including the options of not-participating in the trial or not having the procedure/treatment.

The patient may also be evaluated during the informed consent process to determine their level of understanding and comprehension. Many informed consent papers use highly-technical medical health language, and it may be necessary to provide additional explanations of these terms or ask the user if they understand all of the terms. In one embodiment, certain words may be linked with definitions or further explanations that the user can view by clicking on the word or some annotation near the word.

The patient may be provided with periodic questions during the informed consent presentation which ask about the presentation. The level of aptitude for each patient may be customized by the presentation creator and may depend on each procedure, in which case the patient may not need to answer every question correctly. If the patient doesn't meet a certain level of aptitude by answering a certain threshold amount of questions correctly, the user may be asked to watch a portion of the presentation again. If the patient still does not answer the questions correctly after a second iteration, the presentation may flag the question or section of the presentation for a physician or other health care provider to follow up on directly with the patient to ensure understanding.

If the patient is viewing an informed consent presentation related to a clinical trial, the patient may be asked questions relating to their demographics (to confirm eligibility and availability), be provided with a high-level description of the trial and asked to consent to participation in the trial and use of their medical data obtained during the trial by the company managing the trial, a public health agency or other regulatory body. In one embodiment, the patient may be asked to provide their genomic data.

### Clinical Trial Recruitment Process

In one embodiment, patient medical data from the patient's medical records or information provided by the patient during the informed consent process may be used for a clinical trial recruitment system. The medical data may be stored in a database which can be searched by a company running a clinical trial to identify potential candidates for participation in the clinical trial.

The overall clinical trial recruitment system includes several components which may be used to recruit participants to a clinical trial. The recruitment system may be implemented as a web-based application such as a website which provides information on numerous clinical trials. The website will contain detailed, searchable information on the clinical trials and essentially advertise the clinical trial to a potential participant by providing details on the trial, including who should participate, the location of the trial, the length of the trial, the type of drug, treatment or device being tested, etc. However, the website will be a graphic-based style with visual appeal to the user as opposed to just a laundry list of information. The website may also host a video or other presentation that clearly explains the important information on the clinical trial that a potential participant would be interested in. A user visiting the website can search for a clinical trial based on a particular medical condition, a location of the user and the location of the clinical trial (proximity searching) and many other details relating to the trial, the patient and the treatment.

The website may be designed to guide users to appropriate trials through a series of menus provided on a graphical user interface (GUI) of the website. In one embodiment, the categories of participants listed on a homepage of the website may include patients, healthy volunteers, caregivers, pediatrics, physicians and clinical sponsors. A new user may then be asked to enter their personal profile information, such as their age, weight, height, medical conditions, eating and drinking habits, history or use of smoking, etc. The user may also be able to upload electronic medical records or give the website permission to request access to their EMRs from their doctor or some other type of accessible but secure database. Detailed patient profile information, such as information on the patient's previous experiences in clinical trials, may also be obtained, as this type of profile information may also be useful to identify candidates for related trials on similar or alternative treatments.

The website may also present a bulletin board of available clinical trials that are currently looking for participants. The clinical trials may be listed by category, or may just provide a thumbnail for each category so that a user interested in that category will select the thumbnail to see specific trials. When a certain category is selected, another page will be provided with trials divided by additional more specific types, such as specific conditions, diseases or symptoms that someone is experiencing. For example, selecting a category of “pediatrics” on the homepage will lead to another page where further categories such as “ADHD/ADD, Asthma and Allergy, Bed Wetting, Down Syndrome,” etc. are listed. The website may also provide categories for numerous types of conditions regardless of whether a clinical trial is available, and provide a user with the opportunity to sign up for an alert for a future clinical trial. The data on how many users sign up for alerts for particular conditions or treatments may be used by a researcher or medical company to decide which new area of treatment to pursue.

One benefit of the clinical trial recruitment system is the plurality of patient data which is collected, as this data can be used to not only find patients for existing clinical trials, but also to design clinical trials based on identified symptoms and conditions that are prevalent in the patient medical data. Similarly, the value of a potential clinical trial can be evaluated by determining how many potential patients there are in the clinical trial recruitment system database.

In another embodiment, a link on the clinical trial page may also provide a user with the ability to chat or email with an expert who is helping administer the clinical trial and can answer further questions.

At this point, a specific clinical trial may be selected and a new page with details of the clinical trial will be provided, including short videos explaining the trial, a list of eligibility criteria, links to other websites with additional information, and options for enrolling in the clinical trial, following the clinical trial, or sharing the clinical trial with someone else. The website for the clinical trial may also include a message board for potential participants to ask questions or for the current participants to discuss certain aspects of the trial. A communication tool may also be provided for direct communication with a doctor or clinician. A profile of the doctor or doctors running the clinical trial may also be provided so that a patient candidate can evaluate the doctor's history and expertise in a particular field.

In one embodiment, the website may be configured as a social media tool where users and visitors can share information with each other on clinical trials. Users may be provided with rewards for referring a clinical trial to another user that ends up enrolling in the clinical trial or for participating in the clinical trial themselves. In another embodiment, a rewards system may reward a user for posting a hyperlink with information about the clinical trial on their social media page, broadcast feed, etc. if someone clicks on the hyperlink and enrolls in the clinical trial. Similarly, an advertisement for a clinical trial may be populated on a social media website next to a discussion about a particular condition or disease by using a media scrubber to extract user content from the social media website.

In one embodiment, an “e-flyer” may be used as well, so that each person who views the e-flyer and clicks on the e-flyer to can be tracked in order to provide the appropriate reward to the user who originally posted or shared the e-flyer. Tiered rewards may be available to a variety of users depending on how close they are in the chain of referral to the ultimate end-user that signed up for the clinical trial. Options may be provided for users to send short emails or text messages using the website to potential candidates, further simplifying the process of sharing a clinical trial with another user or guest. The rewards may be any type of monetary or non-monetary reward, such as earning points for an online game, receiving gift cards or discounts, etc.

The clinical trial recruitment system may also use targeted advertising to recruit participants, such as by populating ads when a user types in certain words in a search engine query or when a user uses certain words in an email, on a social media website, etc.

In another embodiment, a doctor, clinic or other health care professional or company may use the clinical trial recruitment system to analyze their lists of patients and patient profiles to identify potential participants in the available clinical trials. The doctor may be provided with a software application resident on their local network that can analyze electronic medical records to sort through the various conditions, symptoms and diagnoses for patients, compare them with the profile information on the clinical trials available and then make recommendations for which patients may be interested in or benefit from certain clinical trials. The system may be designed to work with the provider's electronic health records (EHR) and different formats for medical and genomic data. Alternatively, patient data may be uploaded to a remote server which securely stores patient data but which can also provide an analysis of the patient data against the available clinical trials to recommend certain clinical trials for certain patients that may be a good match. This patient matching service may also be automated to be carried out without the direct supervision or input of the doctor, which saves the doctor time while at the same time providing a greater service to the doctor's patients.

As candidates apply for participation in the clinical trial, they are evaluated and screened to ensure that they are a good match for the clinical trial. Several steps of screening may be carried out to slowly narrow down the potential candidates to a select few which exactly match the type of participant that is needed for a particular clinical trial. For example, a first screening step may include basic tests, like demographic data, a patient's diagnosis, previous medical conditions and any test results. The screening steps may be as specific as looking at a genomic profile to determine if a candidate possesses a specific genome sequence that is relevant to the treatment being performed in the clinical trial. Clinical trials may require a specific sub-set of patients with unique symptoms or conditions in order to determine the effectiveness of a particular treatment or device, and so numerous screening steps may be needed.

In one embodiment, the candidates for a particular clinical trial can be ranked using a proprietary scoring system based on how well a candidate patient's profile matches the criteria for the clinical trial. The profile and criteria may include anything from the location of the patient and the location of the clinical trial to particular genetic code in the patient's genome.

In another embodiment, the clinical trial recruitment system provides for automated follow ups with a patient to evaluate their progress and make assessments. The system may also follow up with users that watch or never enroll in a particular clinical trial in order to determine why they did not enroll and make improvements to the system.

Once a user is enrolled in the clinical trial recruitment system, additional information may be provided to the user, such as analytics on their medical data, coaching and tips for improving their health, and even cautions and warnings for potential side effects or risks of combining incompatible treatments or drugs. Additionally, the patient may be provided with offers for new drugs, treatments, devices, health insurance, patient groups, etc. based on their medical information and the clinical trials they have participated in. The user may also be asked to participate in evaluating the clinical trial and those involved in the clinical trial, in order to provide rankings of the best companies or doctors in the clinical trial industry.

The clinical trial recruitment system is set up to be a neutral host for any type of clinical trial from any company, and the emphasis of the recruitment system will be on helping a patient find the best clinical trial option.

### Computer-Implemented Embodiment

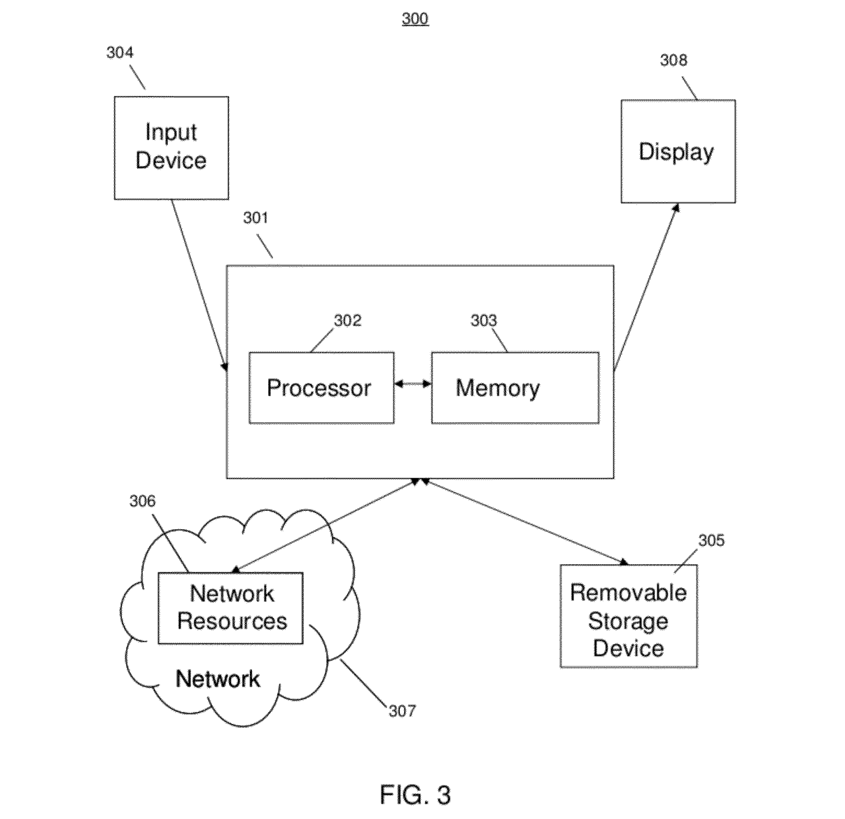

FIG. 3 is a block diagram that illustrates an embodiment of a computer/server system 300 upon which an embodiment of the inventive methodology may be implemented. The system 300 includes a computer/server platform 301 including a processor 302 and memory 303 which operate to execute instructions, as known to one of skill in the art. The term “computer-readable storage medium” as used herein refers to any tangible medium, such as a disk or semiconductor memory, that participates in providing instructions to processor 302 for execution. Additionally, the computer platform 301 receives input from a plurality of input devices 304, such as a keyboard, mouse, touch device or verbal command. The computer platform 301 may additionally be connected to a removable storage device 305, such as a portable hard drive, optical media (CD or DVD), disk media or any other tangible medium from which a computer can read executable code. The computer platform may further be connected to network resources 306 which connect to the Internet or other components of a local public or private network. The network resources 306 may provide instructions and data to the computer platform from a remote location on a network 307. The connections to the network resources 306 may be via wireless protocols, such as the 802.11 standards, Bluetooth® or cellular protocols, or via physical transmission media, such as cables or fiber optics. The network resources may include storage devices for storing data and executable instructions at a location separate from the computer platform 301. The computer interacts with a display 308 to output data and other information to a user, as well as to request additional instructions and input from the user. The display 308 may therefore further act as an input device 304 for interacting with a user.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

We claim:

1. A method for obtaining informed consent from a patient, comprising:
displaying an informed consent presentation to the patient using a computer with a processor, memory and display;
requesting the patient to provide oral consent after the informed consent presentation has finished;
capturing at least one of an audio recording and video recording of the patient providing the oral consent as a multimedia file; and
storing the multimedia file in a database.

2. The method of claim 1, further comprising generating the informed consent presentation based on at least one medical procedure which the patient is about to undergo.

3. The method of claim 1, further comprising generating the informed consent presentation based on a medical history of the patient.

4. The method of claim 3, wherein the medical history of the patient affects the level of risk presented to the patient for a medical procedure.

5. The method of claim 3, wherein the medical history of the patient includes at least one of an electronic medical record (EMR), electronic health record (EHR), personal health record (PHR) and genomic data.

6. The method of claim 1, wherein the informed consent presentation includes a mental capacity test which determines if the patient has the mental capacity to provide informed consent.

7. The method of claim 1, wherein the informed consent presentation includes a reading comprehension test to determine a reading comprehension level of the patient.

8. The method of claim 5, wherein the informed consent presentation is altered based on the level of reading comprehension determined during the reading comprehension test.

9. The method of claim 1, wherein the informed consent presentation includes a content comprehension test which determines if the patient comprehends the information in the informed consent presentation.

10. The method of claim 1, wherein the computer is a tablet with an image capture device which captures the video recording.

11. The method of claim 1, wherein the computer is a tablet with a microphone which captures the audio recording.

12. A system for obtaining informed consent from a patient, comprising:
a presentation unit which displays an informed consent presentation to the patient using a computer with a processor, memory and display;
an interaction unit which interacts with the patient during the informed consent presentation to receive feedback from the patient;
a multimedia capture unit which captures at least one of an audio recording and a video recording of the patient providing oral consent as a multimedia file;
a storage unit which stores the multimedia file in a database.

13. The system of claim 12, further comprising an informed consent generation unit which generates the informed consent presentation based on at least one medical procedure which the patient is about to undergo.

14. The system of claim 13, wherein the informed consent generation unit generates the informed consent presentation based on a medical history of the patient.

15. The system of claim 14, wherein the medical history of the patient includes at least one of an electronic medical record (EMR), electronic health record (EHR), personal health record (PHR) and genomic data.

16. The system of claim 12, wherein the interaction unit receives feedback from the patient relating to a mental capacity test which determines if the patient has the mental capacity to provide informed consent.

17. The system of claim 12, wherein the interaction unit receives feedback from the patient relating to a reading comprehension test to determine a reading comprehension level of the patient.

18. The system of claim 12, wherein the interaction unit receives feedback from the patient relating to a content comprehension test which determines if the patient comprehends the information in the informed consent presentation.

19. The system of claim 12, wherein the computer is a tablet with an image capture device which captures the video recording.

20. The system of claim 12, wherein the computer is a tablet with a microphone which captures the audio recording.
